(19) United States
(12) Patent Application Publication
(10) Pub. No.: US 2026/0206736 A1
(43) Pub. Date: Jul. 23, 2026

(54) ASPHYXIANT GAS TREATMENT SYSTEMS, METHODS, AND APPARATUS

(71) Applicant: FREEZENIT, INC., Marblehead, MA (US)

(72) Inventors: Yair Or, Marblehead, MA (US); Manav Patel, Marblehead, MA (US); Tan Hoang, Marblehead, MA (US); Oreoluwa Adegoke, Marblehead, MA (US); Anthony Rodriguez, Marblehead, MA (US); Carole Spangler Vaughn, Spring, TX (US)

(21) Appl. No.: 19/136,374

(22) PCT Filed: Dec. 8, 2023
(86) PCT No.: PCT/US2023/083130

§ 371 Date: Jun. 6, 2025

Related U.S. Application Data
(60) Provisional application No. 63/431,191, filed on Dec. 8, 2022.

(51) Int. Cl. A01M 1/20

(52) U.S. Cl. CPC A01M 1/2022

(57) ABSTRACT

A treatment system that includes a casing having an internal gas flow path, a treatment outlet, a control valve positioned upstream of the treatment outlet, an asphyxiant gas source, a splitter, a sensor, and an outlet flow capturing device is disclosed. The asphyxiant gas source provides an asphyxiant gas into the flow path, which is received by the splitter and separated into two streams having different temperatures. The outlet flow capturing device can have an interior gas containment region and be arranged to operationally attach to the casing, receive the at least one of the streams and disseminate it within the interior gas containment region over the treatment area to provide a treatment.

### PRIORITY

This application claims the benefit of and priority to U.S. Provisional Application No. 63/431,191, filed on Dec. 8, 2022, the entire teachings of which are incorporated by reference.

### FIELD

The present disclosure generally relates to treatment apparatus, systems, and related methods for providing a treatment, and more particularly to treating a parasitic infestation using a temperature-regulated asphyxiant gas via a temperature regulation system.

### BACKGROUND

Parasitic infestations, such as lice infestation of the human head, is a problem that has been prevalent for many years. Lice are blood-sucking insects that can be the size of a sesame seed. Lice eggs are often known as nits. Nits can range in size from 0.3 mm to 0.8 mm and can cement close to the scalp by female lice. Removal of nits can be difficult due to this natural cement.

In the U.S., there are approximately 12 million lice infestations each year and many of such infestations occur among children aged 3 to 11 years. This number can grow as the human population grows. Traditional methods of treating lice infestation can involve application of topical creams containing active insecticides. However, such treatments can be hazardous to human health and are not always effective because lice can develop a resistance to these insecticides, and hide in human hair and clothing rendering such treatments ineffective.

Non-toxic solutions to lice infestation can include combing and application of heat. However, combing treatments can be extremely time consuming and require multiple days of combing and treatment. Typical heating treatments can also require visits to specialized clinics, which are not always available to the general public. They are also suboptimal in efficacy.

### SUMMARY

The present disclosure relates to treatment techniques such as systems, apparatus, and related methods for treating certain conditions, such as head lice, nit or other parasitic infestations, using a temperature-controlled asphyxiant gas. In some aspects, the present disclosure relates to treating lice and nit infestations on a subject, such as mammal subject or on an article of clothing, furniture, container or other article that may be used by the subject. In various applications, the present disclosure relates to techniques for providing asphyxiant gas, at hot or cold temperature, directly into contact with the infected area of the subject or article. Other applications of the technology can also be made, such as in the treatment of migraines and other similar conditions.

Systems and apparatus disclosed herein will optimally be configured with a flow capturing device, such as a housing, for encapsulating the area to be treated. Such a device can include a container for the article to be treated or a wearable, such as a bonnet or upper body vest or jacket with a hood, to fit on the subject and encompass the affected area on the subject. In general, the device interfaces with a system that generates cold (or hot) asphyxiant gas and delivers it to the subject or article, thereby forming a treatment system. In one aspect, such a treatment system comprises a casing having an internal gas flow path, a treatment outlet, a control valve positioned upstream of the treatment outlet, an asphyxiant gas source, a splitter, a sensor, and an outlet flow capturing device. The asphyxiant gas source is configured to provide asphyxiant gas, for example, from a compressed tank or wall outlet, into the flow path. The splitter has an inlet, first and second channels, a first outlet disposed at a distal end of the first channel, and a vent disposed at a distal end of the second channel and be positioned to receive the asphyxiant gas from the internal gas flow path through the inlet and to separate the asphyxiant gas into first and second streams based on comparative angular fluid velocity or other parameter, such that one gas stream leaves the splitter at a different temperature than the other, with one suitable to provide the desired treatment and the other optionally vented. The first stream may have a first temperature that is colder (or hotter) than the second stream and is therefore suitable for therapy against a parasite, for example. To provide the treatment gas, the splitter is configured to direct the first stream through the first channel and direct the second stream through the second channel, thereby delivering the asphyxiant gas at a cold (or hot) temperature sufficient to substantially kill the lice or other infested parasites in the area. The outlet flow capturing device has an interior gas containment region and is arranged to operationally attach to the casing, receive the first stream from the treatment outlet and disseminate it within the interior gas containment region.

In another aspect, therapeutic methods are provided for application to subjects and articles. In some implementations, a method for treating an individual infected with lice or other infestation in a region of the individual's skin is disclosed. The disclosed method involves placing a bonnet or other housing on the patient about the infected region of skin, providing an assembly with a splitting chamber, providing a flow of asphyxiant gas (e.g., a stream with Carbon Dioxide) into the splitting chamber, separating, in the splitting chamber, a first portion of the flow of asphyxiant gas from a second portion of the flow of asphyxiant gas, the first portion having a different (e.g., lower) temperature than the second portion, and passing the first portion of the asphyxiant gas from the splitting chamber into the bonnet so as to contact the infected region of the skin. Contact can be made for several minutes, as needed, to eradicate the infestation.

In yet another aspect, a method is disclosed for sanitizing an inanimate article that has been exposed to lice or other infestation. The sanitizing method involves placing the article in a container, providing an assembly with a splitting chamber, flowing asphyxiant gas (e.g., Carbon Dioxide) into the splitting chamber where it separates into a first portion and a second portion, the first portion having a different temperature (e.g., colder) than the second portion, and passing the first portion of the asphyxiant gas from the splitting chamber into the container so as to contact the article. Contact can be made for several minutes, as needed, to eradicate the infestation.

In other examples, the aspects above, or any system, method, apparatus described herein can include one or more of the features disclosed herein.

The splitter may be configured with a chamber that provides a vortex force to the incoming asphyxiant gas, such as in a vortex spin chamber. Further, the splitter can include a nozzle. The nozzle can be disposed at the inlet of the splitter and couple with the splitter to direct the gas flow into the splitter. Furthermore, the chamber is positioned between the first and second channels, such that output from the chamber is split into two streams that flow respectively into the channels. The vortex spin chamber can be positioned within the nozzle. Further, an activation switch can be coupled to the inlet of the splitter and configured to control activation of the splitter. The activation switch can be analog or digital. Furthermore, the inlet can be coupled to a pressure or flow valve, configured to control asphyxiant gas flow into the inlet. The valve can be a pneumatic or digital valve.

Further, the distal end of the second channel of the splitter is typically configured with a control valve that can control the output of the treatment stream, for example in the case the stream is too cold or has reached a pre-determined time limit. The control valve can be a conical valve, such as a truncated conical valve.

As indicated, the splitter has at least two channels for the output of the gas into one or more therapy channels. The channels can be positioned relative to each other at a desired angle, each with a pre-configured radius, so as to provide the outlet gas flow at the desired velocity and temperature. In typical applications, one channel receives the first stream (e.g., the cold stream) for outputting the gas into the outlet flow capturing device (e. g, into a treatment container or bonnet), while the other stream is directed out of the casing and vented. The channels will each have an axis, the first channel having a first axis and the second channel having a second axis. The first and second channels of the splitter can be sized and positioned so that their respective axes are oriented at an angle. In some implementations, the first channel axis and an axis of the nozzle can form an angle of approximately 90° or less. The axis of second channel and an axis of the nozzle can form an angle of approximately 90° or less. In some implementations, the axes of the first and second channels can form a 180° angle. The axes of the first and second channels can form an angle ranging between 150°-180°.

the channels may be differentially sized in radius, and the splitter configured such that it directs the first stream into the first channel, so it flows in the first channel at a first angular velocity, and directs the second stream in the second channel so that second stream flows at a second angular velocity, for example where the first angular velocity is lower than the second. This can be accomplished with a chamber that splits the gas into the first and second channels, for example with the first channel having a different (e.g., smaller) internal radius than the radius of the second channel. The differential in radius between the first and second channels provides a difference in angular velocity of the gas flow within the respective channels. For example, the gas in the first channel will have a lower temperature because it passes through a smaller radius at a lower angular velocity, compared to the second which has a larger radius and larger angular velocity. Alternatively, the first angular velocity can be larger than the second angular velocity by vortexing via a larger radius, where the first stream then achieves a higher temperature. Thus, the temperature of the first stream (the first temperature) can be lower than the temperature of the second stream (the second temperature), providing a cold treatment stream.

Alternatively, the temperature of the first stream (the first temperature) can be higher than the temperature of the second stream (the second temperature), providing a hot treatment stream.

The treatment system can be configured with a cartridge, and the splitter can be positioned within the cartridge. The cartridge can have an opening that interfits with the internal gas flow path, forming a path for receiving an inflow of asphyxiant gas. The opening be configured to interfit with the first channel of the splitter. The splitter can be configured with channels that provide the first stream into the outlet flow capturing device at a temperature that is less than 0 ° C., less than −10° C., or less than −20° C. The temperature of the first stream can be approximately −40° C. or lower, in some cases.

The flow capturing device, for example a container or bonnet, can be configured to be disposed adjacent to a treatment surface within the interior gas contaminant region to distribute the first stream over the treatment surface. The interior gas contaminant region can comprise a distribution network of channels that is configured to uniformly distribute the first stream within the flow capturing device.

Further, the flow capturing device can have a distal region with a sealing surface that affixes to the treatment surface and seals the flow capturing device to an area surrounding the treatment surface. The distal region of the flow capturing device can have a sealant formulation configured to retain the second stream within the flow capturing device. Further, the flow capturing device can comprise an exterior surface and configured such that the treatment connector is disposed on the exterior surface of the flow capturing device. In some implementations, the flow capturing device (e.g., the bonnet) is configured to fit about a subject's head. The bonnet can contain an internal region shaped to correspond to and receive hair on the head of a subject. For example, the bonnet can be configured to receive a hair braid, ponytail, or loose bun, and hair gathered up and put into the bonnet. In some implementations, the bonnet includes an inwardly extending diffuser. The diffuser surface can have a surface with a plurality of elongate tips. Further, each elongate tip can have a distal orifice through which the asphyxiant gas can exit the interior gas containment region. Further, in some implementations, the diffuser surface can be shaped as a comb and configured such that the elongate tips extend from a central frame intersperse through the subject's hair. Furthermore, the bonnet can include an inflatable region. The inflatable region extends proximally away from the sealing surface and is used to capture the asphyxiant gas over the treatment area and within the interior surface of the outlet flow capturing device.

The asphyxiant gas is selected so as to have a component that does not support or impedes the respiration of the parasite. In some implementations, the gas includes at least one of Carbon Dioxide, Nitrogen, Oxygen, Helium, or a combination thereof. The asphyxiant gas can be stored in a single-use supply source, for example in a compressed gas cartridge. It may also be supplied from a wall unit with continuous flow. The asphyxiant gas supply source may have a lid or opening configured to receive a replacement gas. In some implementations, the asphyxiant gas supply source is coupled to a mixing valve that is configured to allow mixing of two or more asphyxiant gases. The treatment system can be configured to provide asphyxiant gas into the outlet flow capturing device at a composition of at least 10% Carbon Dioxide. The composition of Carbon Dioxide can be in a range of approximately 20%-40%. In some implementations, the asphyxiant gas can comprise at least 20% Carbon Dioxide or at least 30% Carbon Dioxide. In some implementations, the asphyxiant gas can comprise 100% Carbon Dioxide. Further, the treatment system can be configured to remove air from the first stream to provide Carbon Dioxide in the asphyxiant gas at a composition of at least 80%.

Further, the treatment system can be adapted for use with a monitoring system that provides feedback to the system for safety or other control. In some applications, one or more sensors are used to detect one or more of the temperature, flow rate, composition, or other parameter of the asphyxiant gas flowing in the system. A sensor may be included within the interior gas containment region. For example, the sensor can be a temperature sensor positioned to monitor temperature of the first stream within the interior gas contaminant region. Additionally or alternatively, the treatment system can include a sensor that is positioned between the splitter and the flow capturing device. The sensor can be a chemical sensor configured to monitor concentration of a gas component of the first stream within the interior gas contaminant region. The treatment system can adjust the flow rate of the asphyxiant gas to maintain the asphyxiant gas in the first stream at a predetermined concentration relative to air. Additionally or alternatively, the treatment system can control the flow of asphyxiant gas at a predetermined temperature within the interior gas containment region.

The treatment system can further comprise one or more connectors that couple the treatment outlet from the splitter to the flow capturing device. The flow capturing device can further be coupled with an outlet valve that directs flow away from the interior gas containment region. The outlet valve can be one-way or two-way valve. In certain implementations, a recycle loop can be positioned between a distal end of the outlet valve and the splitter and configured to allow recycling of the stream flowing through the interior gas containment region. Further, a pump can be positioned in the recycle loop and be operable to drive gas from the interior gas containment region to the splitter through the outlet valve.

Systems configured according to the disclosure can be applied by controlling the parameters of temperature and composition of the gas, over a controlled period of time, to achieve substantial eradication of the parasites in the affected area. For example, the flow of asphyxiant gas can be provided at a temperature of −10° C. to −30° C., or at a temperature of 37° C. to 60° C. The asphyxiant gas can be provided for 10-40 minutes. The asphyxiant gas can be provided at a composition of 10% to 40% of asphyxiant gas in air or other gas medium. In some applications, the treatment system is configured to provide the first stream in the outlet flow capturing device at a temperature of −10° C. or lower, for example −20° C. to −30° C., for a period of about 10minutes to 40 minutes (e.g., 20-40 minutes) and having a composition of 10% to 40% Carbon Dioxide (e.g., 20%-40%). The treatment system can be configured to provide the first stream in the outlet flow capturing device at a temperature of 100° F.- 140 ° F., for a period of about 20 minutes to 40 minutes and having a composition of 20% to 40% Carbon Dioxide. Similarly, asphyxiant gas provided at hot temperatures, e.g., a temperature of 100° F. to 140° F., for a period of at least 20 minutes up to 40 minutes and having a composition with 20% to 100% asphyxiant gas may also effective in successful treatment of parasitic infestations. It will be appreciated that numeric values for parameters disclosed herein are intended to include equivalents, for example, a temperature of −10° C. refers to a temperature that is “about −10 C.” which would include nearby temperatures such as −8 and −12° C.

As indicated above, the separation of the first and second portions of the flow of asphyxiant gas can be done by vortexing the flow of asphyxiant gas in the splitting chamber. The first portion of the asphyxiant gas can be at a lower temperature than the second portion. Further, the first portion can be directed to the infected region of the skin.

Additionally or alternatively, the first portion of the asphyxiant gas can flow into the bonnet for a period of about 10-60 minutes. The first portion can further be directed to the article.

In some implementations, the first portion can flow into the container for a period of about 5-60 minutes. The first portion can have a lower temperature than the second portion. For example, the first portion can have a temperature of between −10° C. and −40° C. Additionally or alternatively, the first portion can have a temperature of between −20° C. and −40° C.

The disclosed methods can further involve a step of monitoring concentration of the asphyxiant gas in the bonnet, as a percentage. As noted, the asphyxiant gas comprises Carbon Dioxide, Nitrogen, Oxygen, Helium, or any combination thereof. Further, the asphyxiant gas can be Carbon Dioxide in air. The flow rate of asphyxiant gas into the bonnet can be adjusted in response to the monitoring. Additionally or alternatively, the fit of the bonnet can be adjusted in response to the monitoring. Further, the disclosed methods can involve monitoring concentration of the asphyxiant gas in the bonnet, as a percentage and adjusting the flow rate of asphyxiant gas into the bonnet in response to such monitoring. Additionally or alternatively, the fit of the bonnet can be adjusted in response to the monitoring. The disclosed methods can furthermore include monitoring temperature of the asphyxiant gas flowing into the bonnet and, if the temperature reaches a pre-determined threshold, discontinuing flow of asphyxiant gas into the bonnet.

Other aspects and advantages of the disclosure can become apparent from the following drawings and description, all of which illustrate the various aspects of the inventions disclosed herein, by way of example only.

### BRIEF DESCRIPTION OF THE DRAWINGS

A detailed description of various embodiments is provided herein below with reference, by way of example, to the following drawings. It will be understood that the drawings are exemplary only and that all reference to the drawings is made for the purpose of illustration only and is not intended to limit the scope of the embodiments described herein below in any way. For convenience, reference numerals may also be repeated (with or without an offset) throughout the figures to indicate analogous components or features.

FIG. 1 is a high-level schematic illustration of a treatment system according to some aspects disclosed herein.

FIG. 2 is an illustration of a treatment system according to some embodiments disclosed herein.

FIG. 3 is high-level schematic illustration of an asphyxiant gas source according to some aspects disclosed herein.

FIG. 4 is a high-level schematic illustration of a splitter according to some embodiments disclosed herein.

FIG. 5 includes a table that illustrates the relationship between the number of turns in a valve of a splitter, the initial temperature of the asphyxiant gas entering the splitter, and the final temperature of the stream exiting the splitter in an implementation of a treatment system disclosed herein according to embodiments disclosed herein.

FIGS. 6A-6E include high-level schematic illustrations of an outlet flow capturing device according to some embodiments disclosed herein.

FIGS. 7A-7G include plots that illustrate the relationships between the concentration of the asphyxiant gas that can be achieved over a period of time in various implementations of the flow capturing device according to embodiments disclosed herein.

FIGS. 8A-8D include plots that illustrate the relationships between the temperature of the asphyxiant gas that can be achieved over a period of time in various implementations of the flow capturing device according to embodiments disclosed herein.

FIGS. 9A-9B include tables that demonstrates effect of temperature, time, and percentage carbon dioxide on head lice survival.

FIG. 9C is a bar chart that graphically illustrates data presented in FIG. 9A.

FIGS. 10A-10D are high-level schematic illustrations of treatment systems according to some aspects disclosed herein.

FIG. 11 is another high-level schematic illustration of a treatment system according to some aspects disclosed herein.

FIG. 12 is a high-level block diagram of a digital circuitry that can be used in a treatment system according to some aspects disclosed herein.

### DETAILED DESCRIPTION

The present disclosure relates to treatment techniques such as systems, apparatus, and related methods for treating certain conditions, such as head lice, nits or other parasitic infestations, using a temperature-controlled asphyxiant gas. In some aspects, the present disclosure relates to treating lice and nit infestations on a subject, such as mammal subject or on an article of clothing, furniture, container or other article that may be used by the subject. In various applications, the present disclosure relates to techniques for providing asphyxiant gas, at hot or cold temperature, directly into contact with the infected area of the subject or article. Other applications of the technology can also be made, as will be appreciated from the following discussion of embodiments.

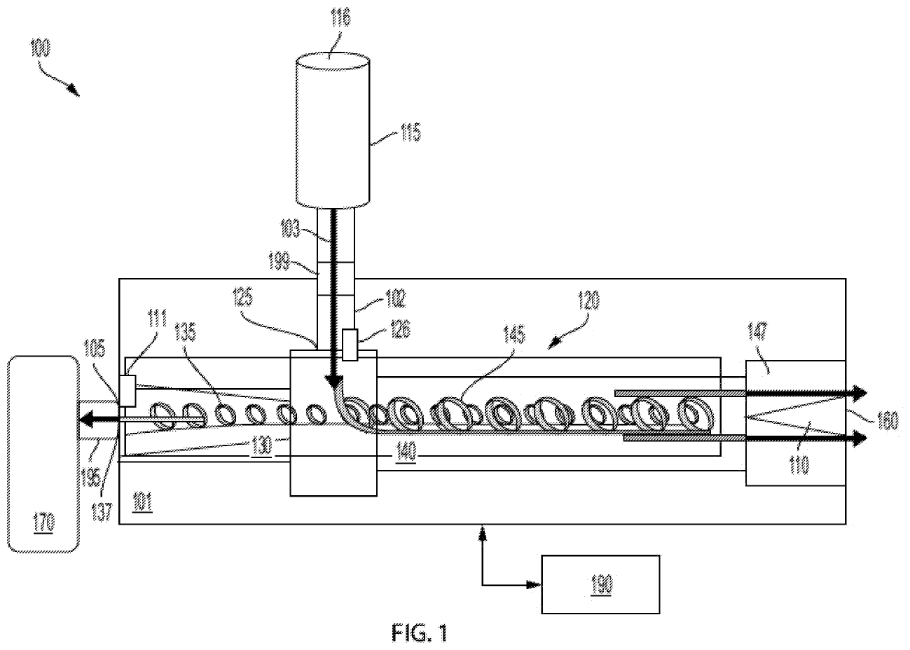

FIG. 1 is a high-level schematic illustration of a treatment system 100 according to some aspects disclosed herein. As shown, the system 100 includes a casing or a housing 101 that comprises an internal gas flow path 102, a treatment outlet 105, and a control valve 110 positioned upstream of the treatment outlet 105. The treatment system 100 further includes an asphyxiant gas source 115 configured to provide asphyxiant gas 103 into the flow path 102.

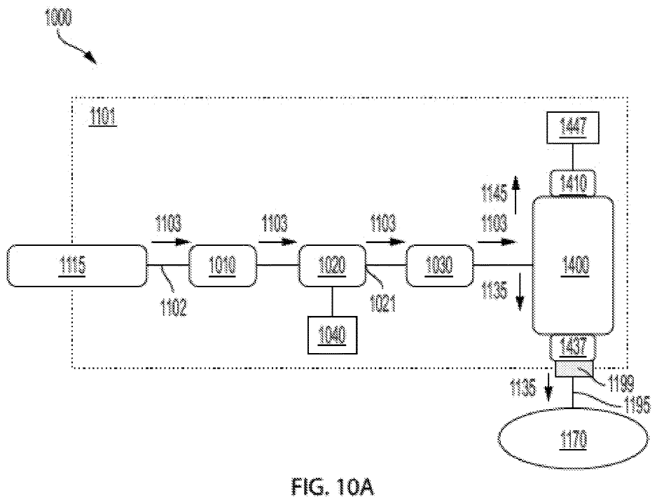

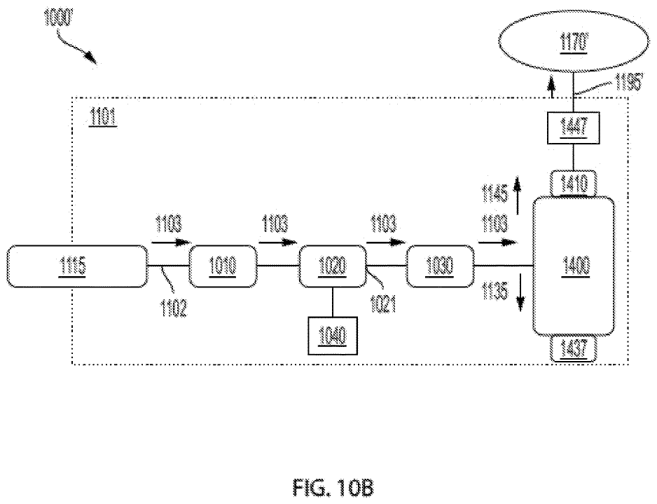

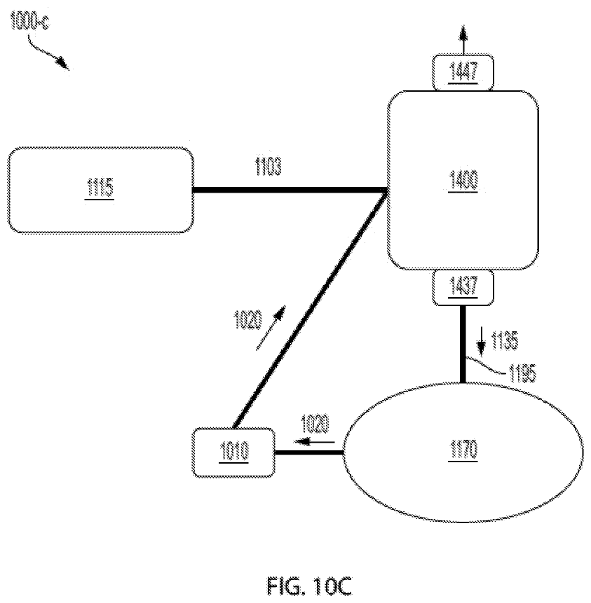

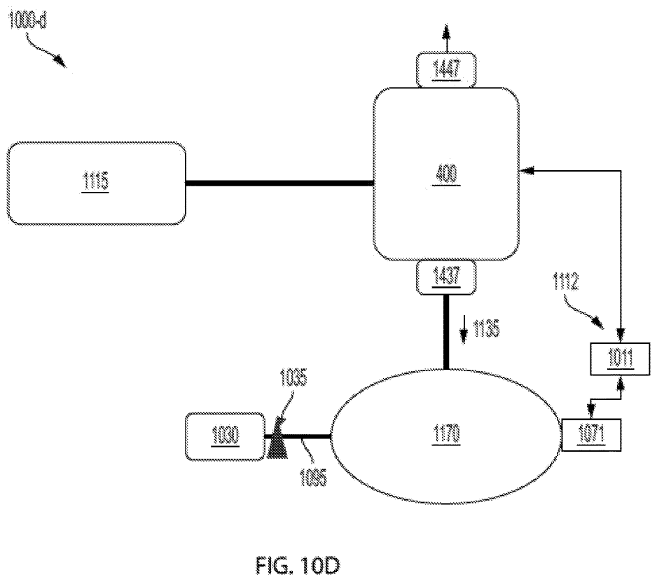

The casing 101 can comprise any suitable material available in the art. For example, the treatment system 110 can be a portable system that includes a three-dimensionally printed (“3D printed) casing 101. The casing can include one or more extrusions that securely support and hold the components of the treatment system 100. Additionally or alternatively, the casing 101 can form a cartridge that contains various components of the treatment system 100. The casing 101 can be configured such that it can be removably or replaceably coupled with the asphyxiant gas source 115. The cartridge has an opening 199 configured to interfit with the internal airflow path 102 for receiving an inflow of asphyxiant gas 103. Alternatively or additionally, as detailed below with reference to FIG. 10A, the opening 199 can be configured to interfit with the first channel 130 and/or the outlet 137 of the first channel 130.

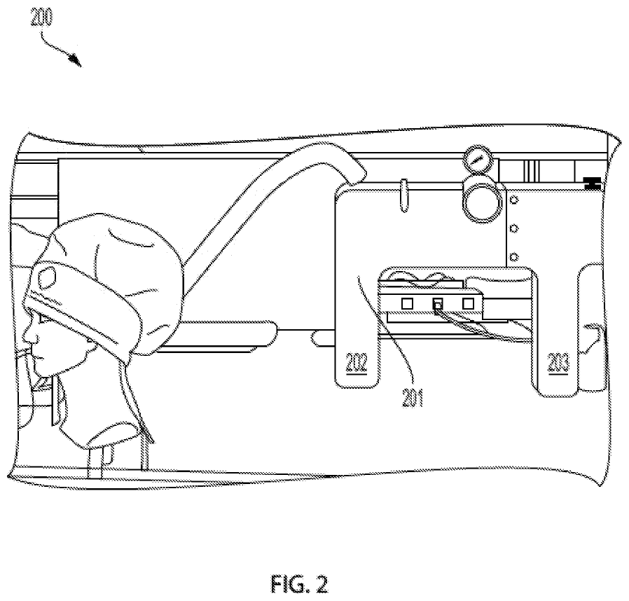

FIG. 2 is an illustration of a treatment system 200 according to some embodiments disclosed herein. As shown in FIG. 2, the casing 201 is self-standing casing via one or more supporting legs 202, 203. The legs 202, 203 allow the user to move the casing and treatment system 200 by holding and handling the casing 201 using the legs 202, 203 and placing the treatment system 200 at a desired location using the legs 202, 203.

Referring back to FIG. 1, the asphyxiant gas source 115 can be any medium capable of carrying a suitable asphyxiant gas for use with the embodiments disclosed herein. Generally, any suitable asphyxiant gas can be used, provided that it does not support or impedes the respiration of the target parasites. Examples of such gases include but are not limited to Carbon Dioxide, Nitrogen, Oxygen, Helium, and a combination thereof. The asphyxiant gas source 115 can be a reusable source capable of providing a supply of asphyxiant gas for administering during multiple treatment cycles using the treatment system. Alternatively or additionally, the asphyxiant gas source 115 can be a single use asphyxiant gas source/reservoir/supply 115, such as in a disposable cartridge. Further, the asphyxiant gas source 115 can be removably and replaceably coupled to the casing 101 such that it can be removed, replaced, and/or refilled as needed. In some implementations, the asphyxiant gas source 115 includes a lid or opening 116 that provides a path for receiving replacement asphyxiant gas.

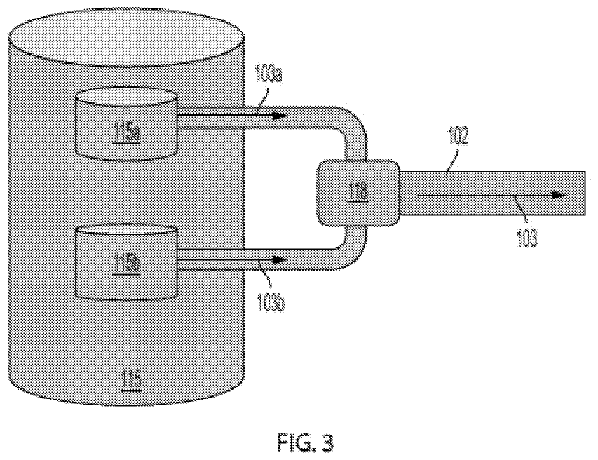

The asphyxiant gas source 115 may include two or more asphyxiant gas sources for storing two or more asphyxiant gases. For example, as shown in FIG. 3, which is a high-level schematic illustration of an asphyxiant gas source 115 according to some aspects disclosed herein, the asphyxiant gas source 115 has two asphyxiant gas sources 115a, 115b, each of which stores an asphyxiant gas 103a, 103b that can be delivered in parallel or mixed prior to inclusion in the splitter.

Mixing of the two gases 103a, 103b is done via a mixing valve 118 that couples with the two or more gas sources 115a, 115b. For example, the first asphyxiant gas source 115a can be a source of an asphyxiant gas 103a, such as Helium, and the second asphyxiant gas source 115b can be a source of another asphyxiant gas 103b, such as Carbon Dioxide. The mixing valve 118 is configured to allow mixing of the two asphyxiant gases 103a, 103b such that the resulting asphyxiant gas 103 entering the fluid path 102 at a predetermined concentration of a certain asphyxiant gas 103a (e.g., a predetermined amount of Carbon dioxide).

The treatment system is configured to provide asphyxiant gas into the outlet flow capturing device at a composition of the desired gas, for example at least 10% Carbon Dioxide. Alternatively or additionally, the composition of Carbon Dioxide can be in a range of approximately 20%-40%. In some implementations, the asphyxiant gas has at least 20% Carbon Dioxide or at least 30% Carbon Dioxide. In some implementations, the asphyxiant gas is 100% Carbon Dioxide. Further, the treatment system can be configured to remove air from the first stream prior to the splitter, to provide a stream having a desired level of a certain asphyxiant gas. For example, the treatment system can be configured to remove air from the first stream to provide a stream having at least 80% asphyxiant gas (e.g., Carbon Dioxide), or even up to 100%.

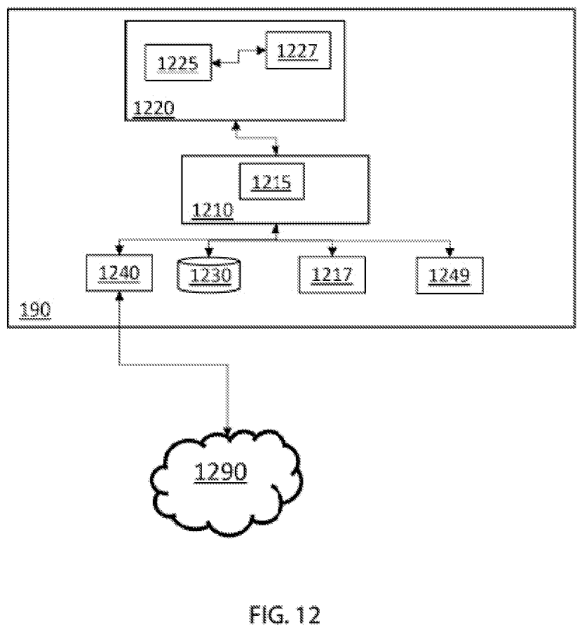

The mixing valve can be a digital valve that is capable of being remotely monitored and controlled. For example, the mixing valve 118 can be coupled to a communications network (shown later in FIG. 12B) such that the operations of the mixing valve 118 can be controlled using remote devices connected to the communications network.

As shown in FIG. 1, the treatment system 110 further comprises a splitter 120 with an inlet 125, first 130 and second 140 channels, a first outlet 137 disposed at a distal end 105 of the first channel 130, and a vent 147 disposed at a distal end 160 of the second channel 140. As detailed below, the splitter 120 is positioned to receive an asphyxiant gas 103 from the internal gas flow path 102 through the inlet 125 and separate the asphyxiant gas 103 into first 135 and second streams 145. The inlet 125 of the splitter 120 can include a switch 126 that controls activation of the splitter 120. The activation switch 126 can be a digital switch that is configured to be controlled by a remote user via an interactive medium. The first 135 and second 145 streams have different temperatures. For example, the first stream 135 has a first temperature, and the second stream 145 has a second temperature that is different from the first temperature. The splitter 120 directs the first stream 135 through the first channel 130, toward the outlet flow capturing device 170 and directs the second stream 145 through the second channel 140 toward a vent 160.

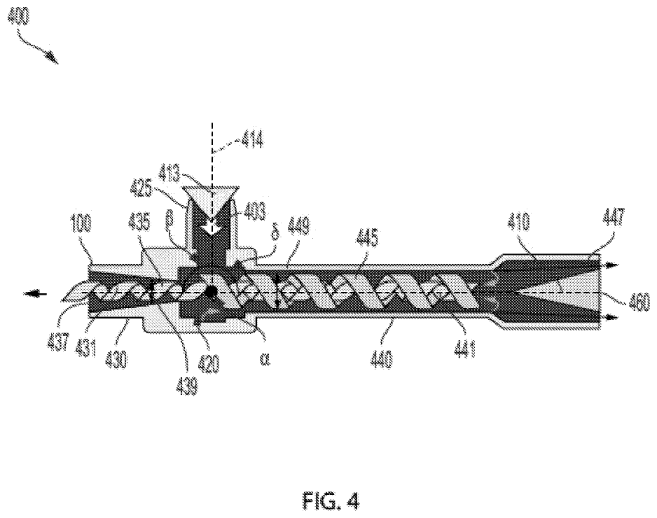

FIG. 4 is a high-level schematic illustration of a splitter 400 according to some embodiments disclosed herein. The splitter 400 is a mechanical device with a chamber receives an in-bound gas flow, such as a compressed gas 403, and applies a force (e.g., via vortex) to the compressed gas 403, such that the gas 403 splits into two streams. Each stream goes through a respective channel (430 and 440), each with a different respective internal diameter 439, 449. Flowing the gas through the different channels results in one gas stream having a higher angular velocity (channel with highest diameter) than the other (the channel with the lower diameter), providing a hot stream 445 and a cold stream 435 exiting from two outlets 437, 447. As detailed elsewhere herein, the desired flow stream (i.e., hot or cold) is selected and directed into the outlet flow capturing device 170. As detailed above, the splitter 400 can be disposed within a cartridge casing 101 that contains various components of the treatment system 100 disclosed herein.

In some implementations, the splitter 400 is a Ranque-Hilsch vortex tube that separates the compressed gas into hot and cold streams. The splitter 400 comprises two channels, namely a first channel 430 and a second channel 440, and a vortex spin chamber 420 that is positioned between the first 430 and second channels.

As detailed above, the splitter 400 is configured to receive pressurized asphyxiant gas 403 from an asphyxiant gas supply (e.g., asphyxiant gas supply 115, shown in FIGS. 1 and 3) via an inlet 425. The splitter 400 can include a nozzle 413 that is configured to direct the stream 403 of asphyxiant gas into the splitter. The nozzle 413 can be disposed at any suitable location, for example at the inlet 425 of the splitter 400. The inlet 425 of the splitter 400 can also be coupled with an activation switch (described with reference to FIG. 1) that controls the activation of the splitter 400.

The asphyxiant gas 403 is injected tangentially into the vortex spin chamber 420 positioned near an end 405 of the splitter distal to the first channel 430. In some implementations, the vortex spin chamber 420 is positioned within the nozzle 413.

Tangential injection of the compressed gas into the vortex spin chamber 420 causes rapid rotation of the asphyxiant gas 403, in an outer vortex stream 445. The outer vortex stream 445 moves in the second channel 440 towards a vent 447 disposed at a distal end 460 of the second channel 440. The distal end 460 of the second channel 440 can comprise a control valve 410.

The control valve 410 receives the outer vortex stream 445 and allows a portion of the outer vortex stream 445 to exit the splitter 400 via the vent 447 and returns the remainder of the asphyxiant gas 403 as an inner vortex stream 435. Accordingly, the control valve 410 separates the outer vortex stream 445 from the asphyxiant gas flow 403 and directs the outer vortex stream 445 out of the casing.

The control valve 410 also controls the amount of asphyxiant gas 403 from the outer vortex stream 445 that exits the splitter 400 via the vent 447. As noted, the remainder of the asphyxiant gas 403 returns to the first channel in the form of an inner vortex stream 435. The inner vortex stream 435 has a diameter that is smaller than a diameter of the outer vortex stream. The inner vortex stream 435 is directed in the first channel 430 to an outlet 437 disposed at a distal end 405 of the first channel 430. The inner vortex stream 435 hereinafter is referenced as the “first stream 435,” while the outer vortex stream 445 hereinafter is referenced as the “second stream 445.”

Further, the control valve 410 is a conical control valve, such as a truncated conical valve. The control valve 410 is configured such that it allows some of the air in the outer vortex stream 445 to exit the splitter 400 via the vent 447 while diverting the rest of the stream back into the second channel 440 towards the first channel 430 as the inner vortex stream 435.

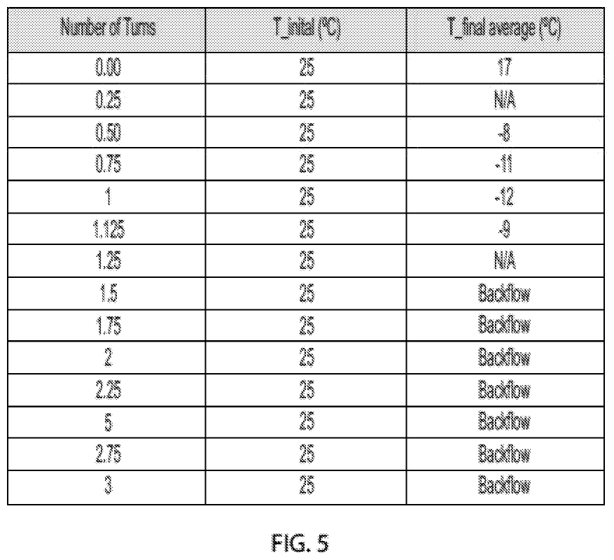

The valve 410 can generally be any suitable control valve, for example a screw valve. The screw valve 410 can be used to control the temperature of the first stream 420 (i.e., the inner vortex stream 435). FIG. 5 includes a table that illustrates the relationship between the number of turns in a screw valve 410, the initial temperature of the asphyxiant gas 403, and the final temperature of the first stream 435 exiting the splitter 400 in an implementation of the treatment system disclosed herein. As shown, the number of turns in the control valve 410 can be used to control the temperature of the first stream 435 exiting the splitter 400.

Referring back to FIG. 4, the first channel 430 of the splitter 400 has an axis 431 (e.g., central axis) and the second channel 440 of the splitter 400 has an axis 441 (e.g., central axis). The first 430 and second 440 channels are positioned such that their respective central axes 431, 441 are oriented at an angle a. In some implementations, the angle α is 180°. Additionally or alternatively, the angle a can be in a range of 150°-180°.

Further, the first channel axis 431 and an axis 414 of the nozzle 413 form an angle β. In some implementations, the angle β can be approximately 90° or less. Additionally or alternatively, the axis 441 of the second channel 440 forms an angle δ with respect to an axis of the nozzle. In some implementations, the angle 8 is approximately 90° or less.

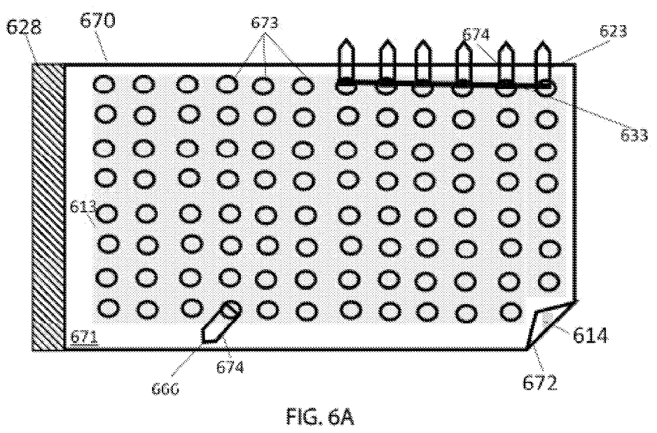

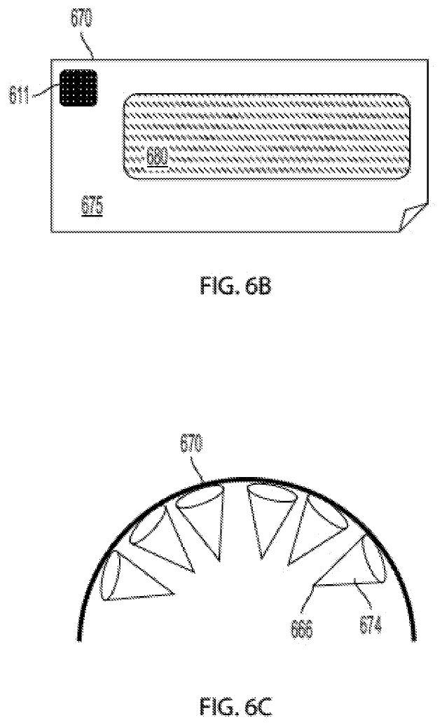

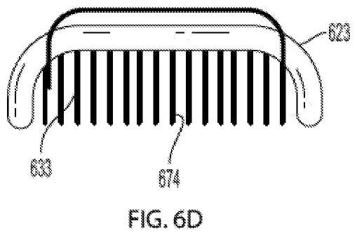

Referring back to FIG. 1, the treatment system 100 has an outlet flow capturing device 170 that receives the treatment gas from the splitter. As detailed below, the outlet flow capturing device 170 includes an interior gas containment region 675 (shown below, with reference to FIG. 6A) that is configured to be disposed adjacent to a treatment area 680 (shown below, with reference to FIG. 6B). The outlet flow capturing device 170 can be arranged to operationally attach to the casing 101, for example via connector 195, to receive the first stream 135 and disseminate the first stream 135 within the interior gas containment region 675.

Further, a sensor 111 can be disposed between the splitter 120 and the flow capturing device. The sensor 111 can be any suitable sensor known in the art. For example, the sensor can be a chemical sensor, a pressure sensor, a composition (e.g., carbon dioxide) sensor, and/or a temperature sensor. In some implementations, the sensor 111 can be configured to monitor at least one characteristic of the first stream 135 before directing the first stream 135 to the flow capturing device 170. For example, the sensor 111 can monitor the temperature or concentration of a gas component (e.g., Carbon Dioxide) of the first stream 135 before directing the first stream 135 to the flow capturing device 170.

The system 100 can utilize the monitoring information obtained from the sensor 111 to control one or more parameters of the first stream 135. Readings from the sensor identify if the temperature of the gas in the first stream 135 gets too low (or too high) for a given treatment protocol, or if the composition of the asphyxiant gas falls below or exceeds a pre-determined range. In such instances, the readings are transmitted and interpreted so as to reduce or increase flow of the gas in the system. For example, the system 100 can use the sensor to monitor the level of a certain asphyxiant gas in the stream 135 and/or the ratio of the asphyxiant gas to air in the stream 135 and if the level/concentration of the asphyxiant gas falls below a predetermined/desired level, use the mixing valve 118 to adjust the level/concentration of the asphyxiant gas flow 103 in the system 100. That control feature can provide a safety mechanism for operation of the device, for monitoring the asphyxiant gas in the first stream 135 that is forwarded to the flow capturing device 170, and adapting the flow of the gas in response to the readings.

In some implementations, a fit of the outlet flow capturing device 170 about the treatment area can be adjusted in the event the level/concentration of the asphyxiant gas falls below a predetermined/desired level. Specifically, as detailed below with respect to FIG. 6A, the outlet flow capturing device 170 can comprise a sealing mechanism 680 that is configured to seal the flow capturing device 170 over the treatment area. The sealing mechanism 680 can be adjusted in the event the level/concentration of the asphyxiant gas falls below a predetermined/desired level to ensure that the flow capturing device 170 is fitted securely over the treatment area. A person having ordinary skill in the art would appreciate that the sealing mechanism 680 should allow some level of air transfer into the outlet flow capturing device 170 in order to prevent explosion of the outlet flow capturing device 170.

FIGS. 6A-6E include high-level schematic illustrations of an outlet flow capturing device 670 according to some embodiments disclosed herein. As explained above, the outlet flow capturing device 670 can be configured to contain, enclose, and/or cover the treatment area 680. The outlet flow capturing device 670 can also be configured to be disposed adjacent to a treatment surface 680, cover the interior gas contaminant region 675 and distribute the first stream 330 over the treatment surface 680 in the interior gas contaminant region 675. The outlet flow capturing device 670 can be connected to the outlet 137 of the first channel 130 via a connector 695 such that it receives the first stream 135 from the splitter in the casing of the treatment system. The connector 695 can comprise an insulating material that prevents heat gain in the first stream 135.

The treatment area 680 can be any area in which temperature regulated asphyxiant gas can be used to treat a condition, such as a parasitic infestation. For example, the treatment area 680 can comprise an item (e.g., a piece of luggage), an object, and/or a portion of a subject's body. In some implementations, the cap 110 is configured to cover a portion of the subject's head or the subject's hair. The cap 110 can comprise a connector 130 that connects the cap 110 to a cooling chamber 140 to receive asphyxiant gas for treating the subject 120 from the cooling chamber 140.

The outlet flow capturing device 670 can be configured to surround and/or enclose the portion of the subject's body, such as a subject's skin, scalp, head, or a subject's hair for treatment of infestations (e.g., lice infestation) in the portion of the subject's body and/or for treatment of certain conditions (e.g., migraines) in the subject. For example, the outlet flow capturing device 670 can be a bonnet, a cap, or a cover that is used to cover and/or enclose a portion of the subject's head or the subject's hair. The bonnet can be configured with an internal region 675 shaped to correspond to and receive the hair on the head, for example a hair braid, ponytail, or loose bun, gathered up and put into the bonnet. The outlet flow capturing device 670 can be positioned and shaped to cover a portion of the subject's skin or cover and/or enclose a subject's limb.

Alternatively, the treatment area 680 can be an article or other object, and the systems and methods applied to treat that object. For example, the treatment area 680 can be on luggage, furniture, mattresses, wallpaper, bedding, clothing, or any other item that may have an infestation, such as items or surfaces where parasites or insects can nest. For example, the treatment area 680 can comprise an item of clothing or bedding used by a person known to have a parasite infestation, such as lice infestation or bed bug infestation. Generally, the treatment area 680 can comprise any item, object, or body part that is infested by a parasite and/or an insect, such as a bed bugs, mites, scabies, lice, and/or similar parasites and/or insects.

The flow capturing device 670 can be disposable and/or reusable. Specifically, in some implementations, the flow capturing device 670 can be a disposable flow capturing device 670 that is disposed after one or a finite number of uses. Generally, the flow capturing device 670 can comprise any suitable material known in the art that can withstand temperatures ranging from−40° C. to 0° C. In some implementations, the flow capturing device 670 can comprise a silicone rubber-based material.

As shown in FIGS. 6A-6E, the flow capturing device 670 can comprise an interior surface 671 that is configured to be placed adjacent to and/or near the treatment area 680 to form the gas contaminant region 675. The flow capturing device 670 can further comprise an exterior surface 672 that is disposed on an opposite side of the interior surface 671.

The interior surface 672 of the flow capturing device 670 can include a fluid distribution network 673 that uniformly distributes the second stream 135 to the treatment area 680 in the gas contaminant region 675. For example, as shown in FIGS. 6A and 6C, the flow capturing device 670 is a bonnet that contains one or more inwardly extending diffusers 673. The diffusers 673 have a surface with one or more elongate tips 674, each having a distal orifice 666 through which the asphyxiant gas stream can exit into the interior gas containment region 675. As shown in FIG. 6D, in some implementations, the diffusers 673 is configured to resemble a hair comb 623 and configured such that the comb 623 comprises a plurality of elongate tips 674, each of which extends from a central frame 633 and is configured to intersperse through the treatment area 680 in the gas contaminant region 675. For example, the comb 623 can be configured such that the elongate tips 674 intersperse through a subject's hair, so as to reach the subject's scalp for increased exposure of the scalp for treatment.

Further, in some implementations, at least one of the interior surface 671 and/or the exterior surface 672 of the flow capturing device 670 has a sealed surface that is configured to minimize and/or prevent leakage of the second stream 135 from the gas contaminant region 675. For example, the flow capturing device 670 has at least one surface 671/672 that has been sealed with a sealant 613/614 to prevent leakage (or substantial leakage) of the second stream 135 from the gas contaminant region 675. For example, the flow capturing device 670 can include at least one sealed surface 671/672 that has been sealed using a Flex Seal aerosol rubber sealant on the inside 671 and/or outside 672 to minimize the occurrence of leakages.

The flow capturing device 670 has a sealing mechanism 628 that is configured to seal the flow capturing device 670 to an area surrounding the treatment area 680, such that the flow capturing device 670 is securely disposed over the treatment area 680 and the gas contaminant region 675. For example, as shown in FIGS. 6A-6C, a sealing mechanism 628 is disposed around the perimeter of the flow capturing device 670 and configured to seal the flow capturing device 670 over the treatment area 680 and the gas contaminant region 675, so that the infected area is disposed within and surrounded by the perimeter of the flow capturing device 670. The sealing mechanism 628 can comprise any suitable sealing mechanism available in the art. For example, the sealing mechanism 628 can comprise an elastic, a comb that is configured to secure the flow capturing device 670 (e.g., a bonnet) against the subject's hair, a tie, a wrap, a Velcro® strap, and/or any other suitable sealing mechanism.

As shown in FIG. 6E, the flow capturing device 670 can have an inflatable region 619 disposed adjacent to the sealing mechanism 628 and/or extending proximally away from the sealing mechanism 628. This configuration can allow the second stream 135 to disburse over the treatment area 680 in the gas contaminant region 675 and fill the space provided by the inflatable region 619, for improved control over the flow within the treatment area.

The flow capturing device 670 can further include at least one sensor 611. The sensor 611 can be any suitable sensor that is disposed in any suitable location in the flow capturing device 670. For example, the sensor 611 can be a temperature or a Carbon Dioxide (CO₂) sensor disposed within the inflatable region 619 of the flow capturing device 670. Alternatively or additionally, the sensor 611 can be disposed on the external surface 672 of the flow capturing device 670. For example, as noted above, the sensor 611 can be disposed in/on the connector 695 and configured to sense the temperature and/or concentration of the CO₂ in the asphyxiant gas (second stream 135) forwarded via the casing to the flow capturing device 670, for regulation of the flow of the gas into the flow capturing device and on to the treatment area.

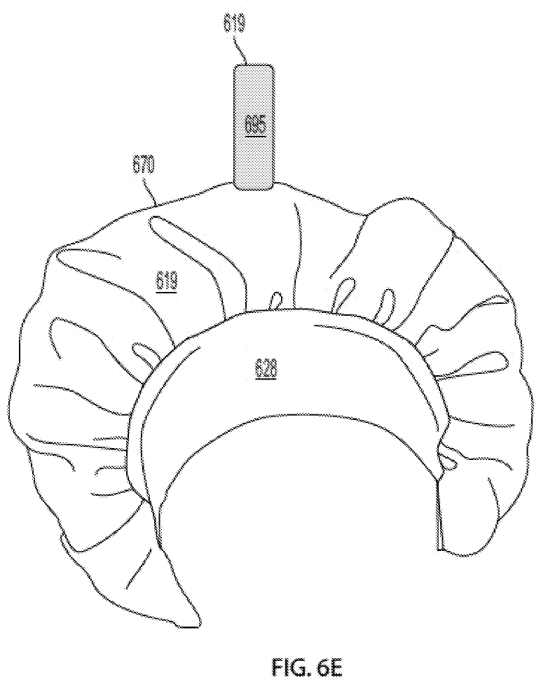

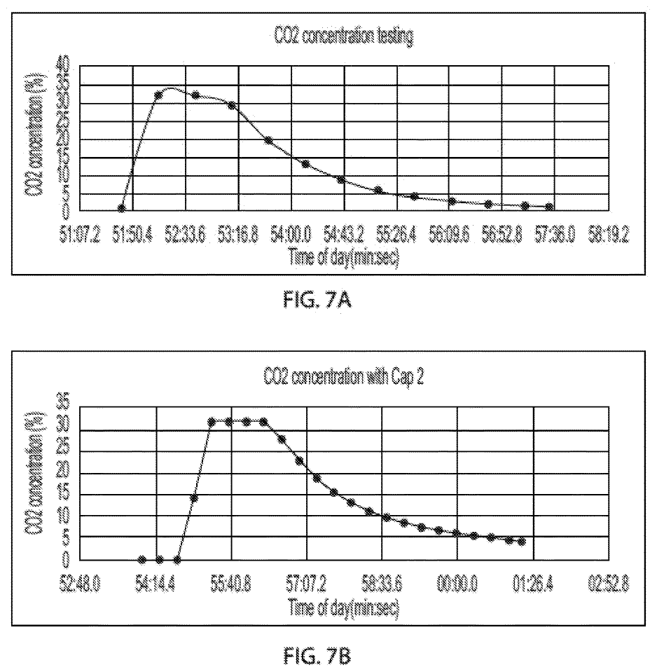

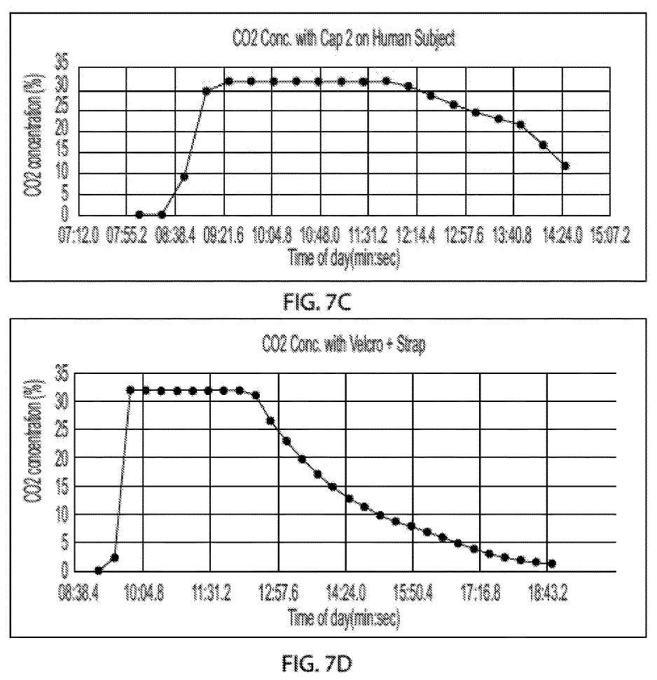

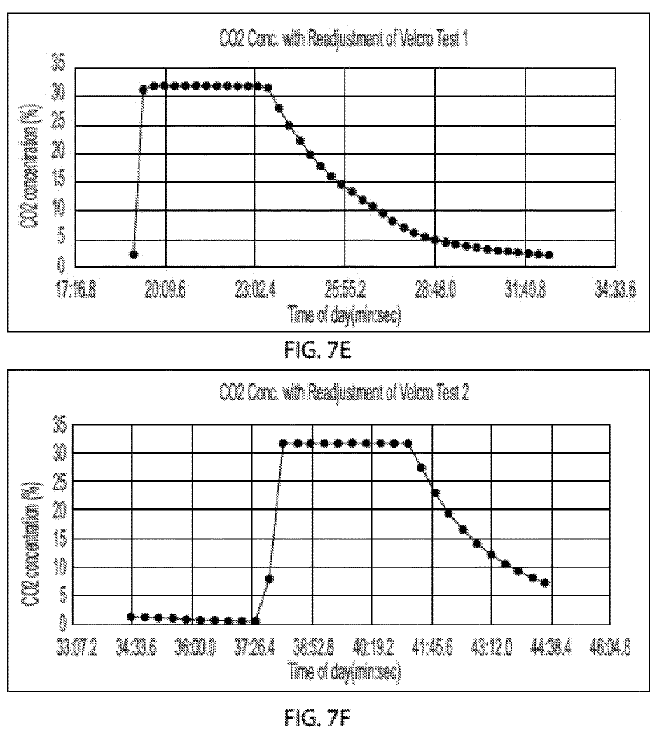

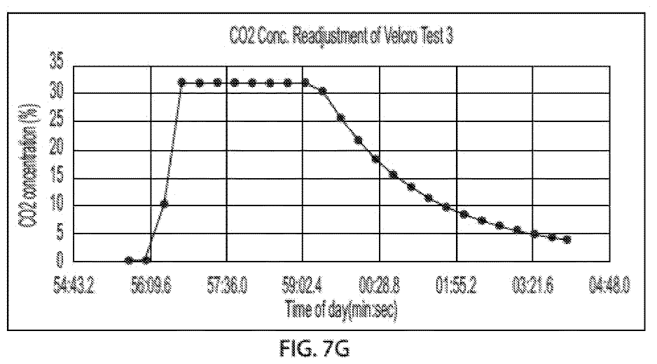

FIGS. 7A-7G include data plots that illustrate the relationships between the concentration of the asphyxiant gas (e.g., CO₂) that can be achieved over a period of time in various implementations of the flow capturing device 670 according to embodiments disclosed herein. In the examples provided in FIGS. 7A-7G, a flow capturing device 670 in the form of a bonnet that includes a Carbon Dioxide sensor (such as is described herein) is used to monitor the concentration of the Carbon Dioxide under the bonnet over a period of time. Each graph is plotted with the Carbon Dioxide concentration level in percentage on the Y-axis, while the time duration of the test is represented on the X-axis. Sensor readings are obtained every 30 seconds in the plot shown in FIG. 7A and every 20 seconds in the plots shown in FIGS. 7B-7F.

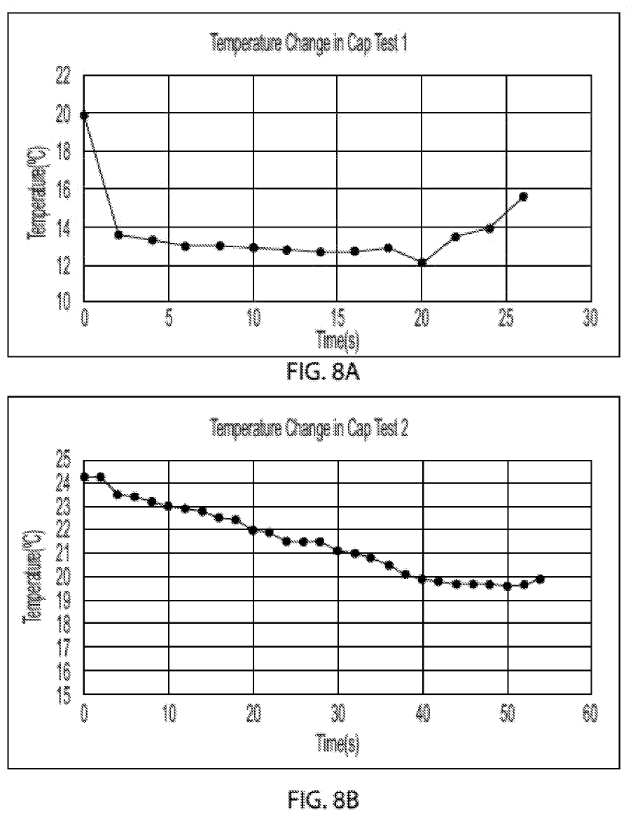

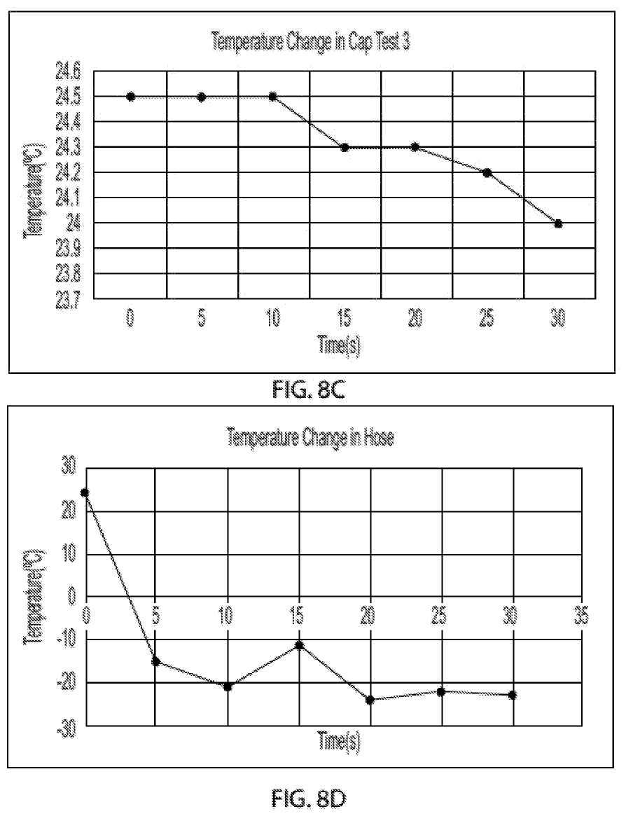

FIG. 7A represents Carbon Dioxide concentration data obtained from the asphyxiant gas in the flow capturing device 670 using a bonnet without sealant 611/614 materials. As shown, the concentration of Carbon Dioxide in the flow capturing device 670 is able to reach about 30% but the flow capturing device 670 is not able to maintain this concentration for longer than a minute. FIG. 8A represents temperature data obtained from the flow capturing device 670 of FIG. 7A.

FIG. 7B represents Carbon Dioxide concentration data obtained from the asphyxiant gas in a flow capturing device 670 with a bonnet that does include a sealant 614 on its exterior surface 672. In this specific example, Flex Seal is used on the outer fabric 672 of the bonnet 670 to help avoid gas permeation and readjust the rubber sealant 628 at the bottom of the flow capturing device 670. In this example, the concentration of Carbon Dioxide in the flow capturing device is maintained for about two minutes before returning to atmospheric levels. FIG. 8B represents temperature data obtained from the flow capturing device 670 of FIG. 7B.

FIG. 7C represents Carbon Dioxide concentration data obtained from the asphyxiant gas in a flow capturing device 670 having the bonnet of FIG. 7B, where the bonnet is physically maintained against the subject's head using the subject's hands. As shown, the concentration of Carbon Dioxide in the flow capturing device is maintained above 30% for at least three minutes. FIG. 8C represents temperature data obtained from the flow capturing device 670 of FIG. 7C.

FIG. 7D represents Carbon Dioxide concentration data obtained from the asphyxiant gas in a flow capturing device 670 comprising the bonnet of FIG. 7B that is physically maintained against the subject's head using, as a sealing mechanism 628, a Velcro® strap and a hairband around the outer rim of the bonnet 670. As shown, this configuration maintains the concentration of the CO₂ in the flow capturing device for a longer time in comparison to the prior configurations.

FIGS. 7E-7G represents data obtained from the flow capturing device 670 of FIG. 7D by controlling the flow of the asphyxiant gas into the casing 101 to achieve consistent exposures to the asphyxiant gas. As shown, controlling the flow of the asphyxiant gas into the casing 101 can result in achieving more consistent concentration of the CO₂ in the flow capturing device for a longer time.

As shown in FIGS. 8A-8C, although the temperature of the first stream 135/435 exiting the splitter 400 initially measures at −48° C., heat gain caused by environmental factors (e.g., live subject body heat, heat introduced by various system components, etc.) can result in an increased temperature of the asphyxiant gas flowing in the flow capturing device 670, which can make it too warm for suitable treatment of parasites. In order to prevent such rise in the temperature of the asphyxiant gas, an insulator 619 is coupled with the connector 695. The insulator 619 can be an insulating layer of material that surrounds the connector 695 and prevents heat gain in the asphyxiant gas stream 135/435. The size of the connector 695 can also be a controlling factor in the amount of heat gain in the asphyxiant gas. For example, in some implementations, connectors 695 having a smaller orifice entrance (e.g., orifice entrance of a ¼″) can ensure that the gas does not expand prematurely so that it can maintain the coldest temperature it can achieve for as long as possible. Furthermore, as noted, sealing mechanisms 628 and sealants 613/614 can contribute to protection of the gas from possible heat again that may result due to exposure to ambient. As shown in FIG. 8D, data obtained using an insulated connector coupled with the flow capturing device 670 of FIG. 7D illustrate that the temperature of the asphyxiant gas in the flow capturing device 670 can be maintained under −10° C. during the period of the test.

As detailed above, the treatment systems disclosed herein can be used to treat infestations, such as lice and other insect infestations in objects and live subjects (specifically mammals). It is known that head lice are susceptible to changes in their environment, being prone to dehydration, if deprived of a blood meal, susceptible to changes in temperature that may render them immobile of even kill them.

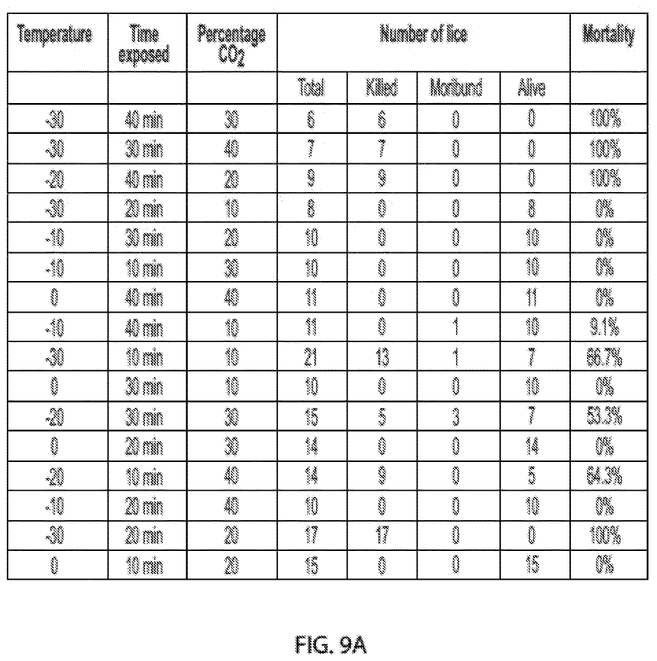

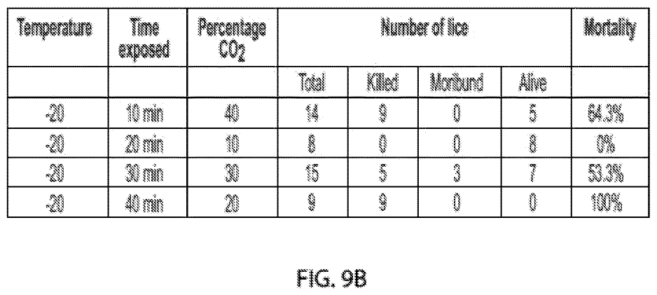

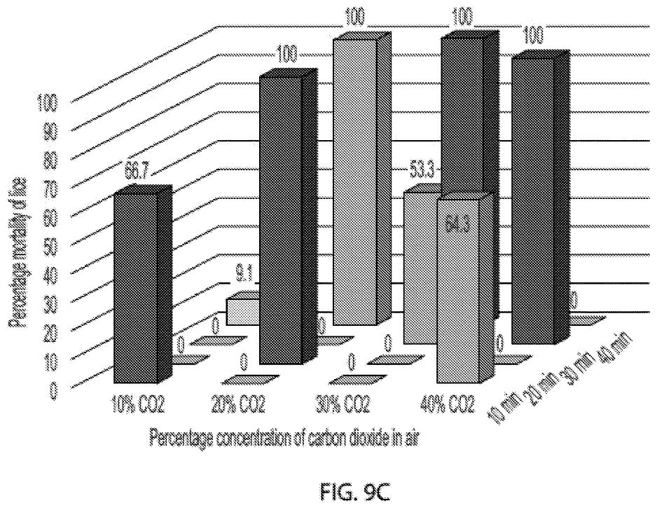

FIGS. 9A-9B are tables that include data obtained from a series of tests to demonstrate the effect of temperature, asphyxiant gas concentration, and length of treatment in substantially eradicating the parasites. FIG. 9C is a bar chart that graphically illustrates data presented in FIG. 9A. Head lice were collected from schoolchildren in the locality of Cambridge city, UK. Some were collected from an individual who has regularly suffered problem infestations for several years and the others collected from several children in local schools that were visited during the month of November of 2023.

Lice were captured by dry detection combing and transferred to plastic containers fitted with a filter disc base for the lice to grip during transfer to the laboratory. In the laboratory, lice were counted into batches of at least 10 insects and placed initially into 55 mm diameter marked plastic Petri dishes, but for some batches the number used was greater if sufficient lice were available. Lice were subsequently subject to low temperature asphyxiant gas, with varied composition for predetermined periods of time to obtain the results shown in FIGS. 9A-9B.

Upon removal from the tubes and after cooling, all lice appeared immobile. However, as time progressed, some level of motility was observed in some of the groups of insects. This occurred initially with the smallest nymphs and began with simple twitches of claws and extremities and extended to whole limbs and in some cases to full motility.

However, Adult lice were slower to recover. In some tests, one or two smaller lice were lost during the process if they became stuck to the wall of the test tube during the cooling process (these instances were not recorded in the test results). Outcomes for the various exposure tests are shown in the table shown in FIG. 9A.

As indicated, 100% lice were eliminated when the system was operated at a temperature of −20 C to −30 C., for a period of 20 minutes to 40 minutes, and having a composition of 20% to 40% Carbon Dioxide Adjusting the parameters to similar temperatures in lower concentrations of Carbon Dioxide during similar time periods eradicated some (and many in some cases) but not all lice. Operating at higher temperatures (e.g., 0 C) with similar concentrations of Carbon Dioxide (20% to 40% Carbon Dioxide) and over similar time periods (20 minutes to 40 minutes was not effective. The effect of temperature appeared to be an important factor influencing outcome with no mortality, irrespective of exposure time or carbon dioxide concentration, at 0° C. Similarly, at −10° C., lice showed no mortality for any of the other parameters, other than one louse being immobilized but not killed (i.e., it was still showing limb and gut movements, when exposed for 40 minutes at −10° C.). Consequently, temperature did not affect the lice unless at −20° C. or below (FIG. 9A).

From the groups exposed to temperature of about −20° C., it appears that the concentration of carbon dioxide has a marginally greater effect to kill the lice than the time of exposure because when using the highest concentration of 40%, two third of the lice were killed using only 10 minutes of exposure, whereas reducing the carbon dioxide by just 10% gave a relative reduction even when exposed for 30 minutes (FIG. 9B). However, when operating at a temperature of about −30° C., all lice were killed, except at the shortest exposure time of 10 minutes in combination with just 10% carbon dioxide (FIG. 9A).

As illustrated by the results provided in FIGS. 9A-9B, temperature can be a significant primary factor in mortality, and the longevity of exposure and carbon dioxide concentration are not as critical for ensuring that lice are killed. However, as maintaining the temperature within some form of head covering is impacted by heat arising from the skin of the scalp, targeted temperature of −30° C. can be difficult to maintain in isolation but the position effects of the system can be more efficiently achieved using asphyxiant gas in combination. Therefore, embodiments disclosed herein rely on low temperatures (e.g., in the range of −20° C.) in conjunction with use of an asphyxiant gas with a high carbon dioxide concentration, for controlled period of time, to achieve successful treatment of parasitic infestations. For example, asphyxiant gas provided at a temperature of −10° C. to −30° C. (e.g., −20° C. to −30° C.) for a period of 10 minutes to 40 minutes (e.g., 20-40 minutes), and having a composition of 10% to 40% Carbon Dioxide (e.g., 20-40%) may be effective in successful treatment of parasitic infestations. Similarly, asphyxiant gas provided at hot temperatures, e.g., a temperature of 100° F. to 140° F., having a composition with 20% to 100% asphyxiant gas may also be effective in successful treatment of parasitic infestations. Time of treatment can be selected as needed. Time of treatment can be at least 10 minutes, or at least 20 minutes, or for a period of at least 20 minutes up to 40 minutes.

FIG. 10A is a high-level block diagram of a treatment system 1000 according to some embodiments disclosed herein. As detailed above, the treatment system 10000 utilizes a splitter that creates a vortex 1400 to reduce the temperature of an asphyxiant gas 1103 supplied by an asphyxiant gas source 1115. The asphyxiant gas source 1115 can generally be any asphyxiant gas source available in the art. For example, the asphyxiant gas source 1115 can be a cannister that contains a compressed asphyxiant gas 1103, such as compressed carbon dioxide (CO2) (e.g., a 60-litter canister of an asphyxiant gas, such as CO2). The asphyxiant gas 1103 is delivered into the casing 1101 of the treatment system 1000 via a fluid flow path 1102. The fluid path 1102 of the asphyxiant gas source 1115 is coupled to a valve 1010 (e.g., a pin valve) that controls the flow of gas 1103 supplied by the asphyxiant gas source 1115. For example, in some implementations, the asphyxiant gas source 1115 comprises a safety pin and brake hose for fitting and minimal leakage.

In some implementations, the flow capturing device 1170 can comprise an outlet valve 1171 that directs flow away from the interior gas containment region. The outlet valve 1171 can be one-way or two-way valve. In certain implementations, a recycle loop 1112 can be positioned between a distal end of the outlet valve 1171 and the splitter 400 and configured to allow recycling of the stream flowing through the interior gas containment region. Further, a pump 1011 is positioned in the recycle loop 1112 and is operable to drive the gas from the interior gas containment region to the splitter 400 through the outlet valve 1171.

A pressure regulator 1020 can be utilized to control the pressure of the asphyxiant gas 1103 supplied by the asphyxiant gas source 1115. For example, in some implementations, asphyxiant gas 1103 is released from the asphyxiant gas source 1115 at high pressures, for example a pressure of 830 psi. The pressure regulator 1020 can be used to control the pressure of the asphyxiant gas 1103 flowing into the treatment system 1000. For example, in some implementations, a pressure regulator 1020 with a maximum inlet pressure of 4350 psi and an exit pressure of 125 psi is utilized. The pressure regulator 1020 can also contain a relief valve that opens when pressure in the line reaches a pre-determined threshold, for example 250 psi over a maximum inlet pressure, such that the regulator provides a safety factor (e.g., a factor of at least 3, 4, or greater than 5, including 5.24), despite the high pressure coming out of the cannister.

The outlet 1021 of the pressure regulator 1020 can include a series of brass pipe elbows and steel nipples that allow a connection into a splitter 1400. For example, the outlet 1021 of the pressure regulator 1020 can comprise a backflow regulator 1030 that prevents leakage and/or backflow of the asphyxiant gas 1103 entering the splitter 1400. The backflow regulator 1030 can generally be any leakage and/or backflow regulator known in the art. For example, in some implementations, a ball valve and/or a sealant such as a Teflon® tape can be used to prevent leakage of the asphyxiant gas 1103 flowing from the pressure regulator 1020 to the splitter 1400.

As detailed with reference to FIG. 4, the splitter 1400 can be a mechanical device that is configured to split the compressed asphyxiant gas 1103 into hot 1145 and cold 1135 streams exiting from two outlets. For example, the splitter 1400 can be configured to split the compressed asphyxiant gas 1103 into an outer vortex stream 1145 that travels towards a valve 1410. The valve 1410 allows some of the outer vortex stream 1145 to exit the splitter via a vent 1447 while returning the remainder of the compressed asphyxiant gas 1103 as an inner vortex 1135 to an outlet 1137. The inner vortex stream 1135 can have a temperature that is different and lower from the temperature of the outer vortex 1145. The outlet 1137 can comprise an opening 1199 that is configured to interfit with a connector 1195 of an outlet flow capturing device 1170. The connector 1195 directs the inner vortex stream 1135 into the outlet flow capturing device 1170 and allows the inner vortex stream 1135 to fill the space between the treatment area and an interior surface of the outlet flow capturing device 1170. This configuration allows introduction of pressurized temperature controlled asphyxiant gas within the enclosed space formed by outlet flow capturing device 1170 over the treatment area. As detailed with reference to FIGS. 9A-9B, embodiments disclosed herein can successfully treat infestations (e.g., insect infestations) in objects, surfaces, or subjects by exposing an enclosed treatment area to a low temperature asphyxiant gas, thereby exterminating the infestations in the treatment area using a combination of asphyxiation (suffocation) and freezing the parasites in the treatment area.

The connector 1195 can comprise an insulator, such as a high-density polyethylene (HDPE) adapter, which is attached to the outlet of the splitter 1400. Insulators, such as HDPE insulators, can insulate the temperature-controlled gas stream from environmental factors and maintain the temperature of the gas stream. For example, in one implementation, an insulating adapter can be used in conjunction with a PVC-based outlet flow capturing device 1170, which is fitted to the connector of the outlet flow capturing device 1170 using silicone tubing that is capable of withstanding temperatures from −65° F. to 190° F. In some implementations, the outlet flow capturing device 1170 can be used in conjunction with a casing that has been 3-dimensionally printed using a plastic, such as an Acrylonitrile butadiene styrene (ABS) plastic.

As shown in FIG. 10B, in some implementations 1100′, the outlet flow capturing device 1170′ is coupled to the vent 1170′ and configured to receive the portion of the outer vortex stream that exits the casing 1101 through the valve 1410. As noted above, the outer vortex stream 1145 can have a temperature that is different from (e.g., higher than) the inner vortex stream. For example, the outer vortex stream can have a temperature ranging from 100° F.- 140° F. Further, in some implementations, the outer vortex stream can have a temperature that is higher than 138° F. Additionally or alternatively, in some implementations, the outer vortex stream can have a temperature ranging between 130° F. 140° F.

A connector 1195′ is positioned to direct the outer vortex stream 1137 into the outlet flow capturing device 1170′ and allow the outer vortex stream 1137 to fill the space between the treatment area and an interior surface of the outlet flow capturing device 1170′. This configuration allows introduction of pressurized temperature controlled asphyxiant gas within the enclosed space formed by outlet flow capturing device 1170 over the treatment area, thereby exterminating infestations in the treatment area using a combination of heat and asphyxiation gas.

Referring now to FIG. 10C, in some implementations, the treatment systems 1000-c disclosed uses an electric pump 1010 that is attached to the outlet flow capturing device 1170 and configured to extract residual air from the interior gas containment region prior to introduction of the asphyxiant gas to the treatment area. Specifically, as shown in FIG. 10C, the pump 1010 can be attached to the outlet flow capturing device 1170 and configured to remove (e.g., via suction) residual air 1020 from the interior gas containment region that may be in the space between the interior surface of the outlet flow capturing device 1170 and the treatment area. A flow of temperature controlled asphyxiant gas can then be introduced into the space via the splitter 1400. For example, the splitter 1400 can forward a flow of asphyxiant gas having reduced temperature 1135 to the outlet flow capturing device 1170 via the connector 1135. This configuration can maximize the percent volume of the asphyxiant gas (e.g., carbon dioxide) residing in the outlet flow capturing device 1170, thereby increasing the effectiveness of the treatment system.

In some implementations, the air 1020 extracted from the outlet flow capturing device 1170 is recirculated into the splitter 1400 to allow the continuous cooling (or heating) of the enclosed space. Specifically, as the compressed gas initially travels into the outlet flow capturing device 1170, it is applied to the treatment area and siphoned out through the pump 1010 and recirculated back into the splitter 1400 to repeat the recirculation process. This would not only allow a higher amount of time that the asphyxiant gas flows through the cap, but also allows for reusing the leftover asphyxiant gas that is not expelled through the vent 1447 of the splitter 1400.

Referring to FIG. 10D, the treatment system 1000-d can further include a flow regulator 1035, such as a two-way valve, as well as a pressure equalizer 1030. As air is typically lighter than asphyxiant gases, such as carbon dioxide, a pressure equalizer 1030 can be used to move the flow of air in the outlet flow capturing device 1170 out of the outlet flow capturing device 1170 and into the pressure equalizer 1030. Removal of the air in the outlet flow capturing device 1170 allows the asphyxiant gas 1135 to freely flow in the outlet flow capturing device 1170 and over the treatment area. A flow regulator 1035 can be coupled to the connection 1095 between the outlet flow capturing device 1170 and the flow regulator 1035 to allow adjustment of the air flow between the flow regulator 1035 and the outlet flow capturing device 1170.

Referring back to FIG. 1, the treatment system 100 can further include digital circuitry 190 to monitor the various functions and components of the treatment system 100. Although shown as being disposed outside of the casing 101, a skilled person would understand that the digital circuitry can be disposed at any suitable location within the treatment system.

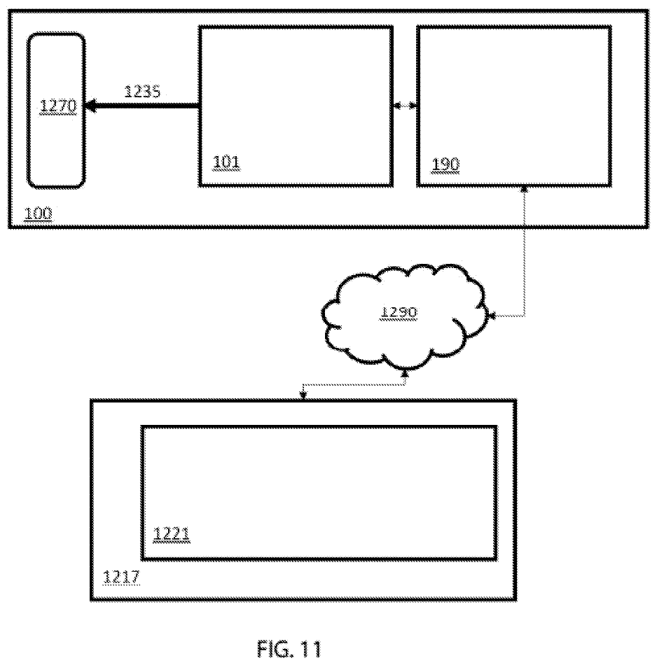

FIG. 11 is a high-level block diagram of a treatment system 100 according to some aspects disclosed herein. As shown the treatment system 100 has a casing 101 that contains various components detailed with reference to FIGS. 1-10, such as an air pathway for receiving a high pressure asphyxiant gas, a splitter for dividing the asphyxiant gas into two streams having differing temperatures, and an outlet flow capturing device 1170 that is disposed over or adjacent to the treatment area and is configured to enclose the treatment area and distribute a stream of the asphyxiant gas (e.g., a stream of cold asphyxiant gas) into an interior gas containment region over the treatment area in order to administer a treatment. This can be done to exterminate parasites (e.g., insects) in the treatment area. At least one component of the treatment system 100 can be controlled by a digital circuitry 190.

FIG. 12 is a high-level block diagram of a digital circuitry and hardware 190 that can be used with, incorporated in, or fully or partially included in a treatment system according to some embodiments disclosed herein. The electric circuitry 190 can include a processor 1210 that is configured to monitor the operation of the treatment system, send and/or receive signals regarding the operation of the treatment system, and/or control the operation of the treatment system.

The processor 1210 can be configured to collect or receive information and data regarding the operation of the treatment system 100 and/or the outlet flow capturing device 1270 and/or store or forward information and data to another entity (e.g., another portion of a treatment system, a treatment clinic, etc.). The processor 1210 can further be configured to control, monitor, and/or carry out various functions needed for control, analysis, interpretation, tracking, and reporting of information and data collected by the treatment system 100 (for example, functions carried by the components of the casing 101 shown in FIG. 1). Generally, these functions can be carried out and implemented by any suitable computer system and/or in digital circuitry or computer hardware, and the processor 1210 can implement and/or control the various functions and methods described herein.

The processor 1210 can be connected to a main memory 1220 and comprise a central processing unit (CPU) 1215 that includes processing circuitry configured to manipulate instructions received from the main memory 1220 and execute various instructions. The CPU 1215 can be any suitable processing unit known in the art. For example, the CPU 1215 can be a general and/or special purpose microprocessor, such as an application-specific instruction set processor, graphics processing unit, physics processing unit, digital signal processor, image processor, coprocessor, floating-point processor, network processor, and/or any other suitable processor that can be used in a digital computing circuitry. The processor can comprise at least one of a multi-core processor and a front-end processor.

Generally, the processor 1210 and the CPU 1215 can be configured to receive instructions and data from the main memory 1220 (e.g., a read-only memory or a random-access memory or both) and execute the instructions. The instructions and other data can be stored in the main memory 1220. The processor 1210 and the main memory 1220 can be included in or supplemented by special purpose logic circuitry. The main memory 1220 can be any suitable form of volatile memory, non-volatile memory, semi-volatile memory, or virtual memory included in machine-readable storage devices suitable for embodying data and computer program instructions. For example, the main memory 1220 can comprise magnetic disks (e.g., internal or removable disks), magneto-optical disks, one or more of a semiconductor memory device (e.g., EPROM or EEPROM), flash memory, CD-ROM, and/or DVD-ROM disks.

The main memory 1220 can comprise an operating system 1225 that is configured to implement various operating system functions. For example, the operating system 1225 can be responsible for controlling access to various devices, memory management, and/or implementing various functions of the treatment system 100. Generally, the operating system 1225 can be any suitable system software that can manage computer hardware and software resources and provide common services for computer programs.

The main memory 1220 can also hold application software 1227. For example, the main memory 1220 and application software 1227 can include various computer executable instructions, application software, and data structures, such as computer executable instructions and data structures that implement various aspects of the embodiments described herein. For example, the main memory 1220 and application software 1227 can include computer executable instructions, application software, and data structures, such as computer executable instructions and data structures that implement interface (e.g., an application program interface), which can be employed by a user to communicate with treatment system 100 in order to, for example, control the operations of the treatment system 100.

Generally, the functions performed by the treatment system 100 can be implemented and controlled via digital electronic circuitry or computer hardware that executes software, firmware, or combinations thereof. The implementation can be as a computer program product (e.g., a computer program tangibly embodied in a non-transitory machine-readable storage device) for execution by or to control the operation of a data processing apparatus (e.g., a computer, a programmable processor, or multiple computers).

The main memory 1220 can also be connected to a cache unit (not shown) configured to store copies of the data from the most frequently used main memory 1220.

The program codes that can be used with the embodiments disclosed herein can be implemented and written in any form of programming language, including compiled or interpreted languages, and can be deployed in any form, including as a stand-alone program or as a component, module, subroutine, or other unit suitable for use in a computing environment. A computer program can be configured to be executed on a computer, or on multiple computers, at one site or distributed across multiple sites and interconnected by a communications network, such as the Internet 1290.

The processor 1210 can further be coupled to a database or data storage 1230. The data storage 1230 can be configured to store information and data relating to various functions and operations of the treatment system 100. For example, the data storage 1230 can store the data collected by the treatment system 100, which can include subject information, treatment information, asphyxiant gas pressure, composition, and temperature, treatment duration, extermination results, etc.

The processor 1210 can further be coupled to a display 1217. The display 1217 can be configured to receive information and instructions from the processor, display information to a user of the treatment system, receive information and commands from the user, and forward the received information and commands to the processor 1240. The display 1217 can generally be any suitable display available in the art, for example a Liquid Crystal Display (LCD) or a light emitting diode (LED) display. For example, the display 1217 can be a smart and/or touch sensitive display that can receive instructions and commands from a user and/or provide information to the user. The instructions can include any suitable instructions. For example, a user can use the interactive display to provide instructions for engaging the activation switch 126 (FIG. 1) and controlling the activation of the splitter.

The processor 1210 can further be connected to various interfaces. The connection to the various interfaces can be established via a system or an input/output (I/O) interface 1249 (e.g., Bluetooth, USB connector, audio interface, FireWire, interface for connecting peripheral devices, etc.). The I/O interface 1249 can be directly or indirectly connected to the treatment system 150 to allow the user to communicate via the interface with the treatment system 150.

The processor 1210 can further be coupled to a communication interface 1240, such as a network interface. The communication interface 1240 can be a communication interface that is included in the treatment system 100 and/or a remote communications interface 1240 that is configured to communicate with the treatment system 1240. For example, the communications interface 1240 can be a communications interface that is configured to provide the treatment system 100 with a connection to a suitable communications network 1290, such as the Internet. Transmission and reception of data, information, and instructions can occur over the communications network 1290.

Further, in some embodiments, the communications interface 1240 can be an interface that is configured to allow communication between the digital circuitry 190 (e.g., a remote computer) and the treatment system 100 (e.g., via any suitable communications means such as a wired or wireless communications protocols including WIFI and Bluetooth communications schemes).

While the foregoing has described example embodiments, it is understood that various modifications may be made therein and that the invention or inventions disclosed herein may be implemented in various forms and embodiments, and that they may be applied in numerous applications, only some of which have been described herein.

1. A treatment system comprising:
a casing having an internal gas flow path, a treatment outlet, and a control valve positioned upstream of the treatment outlet,
an asphyxiant gas source configured to provide asphyxiant gas into the flow path,
a splitter having an inlet, first and second channels, a first outlet disposed at a distal end of the first channel, and a vent disposed at a distal end of the second channel,
the splitter being positioned to receive asphyxiant gas from the internal gas flow path through the inlet and configured to separate the asphyxiant gas into first and second streams, wherein the first stream has a first temperature, and the second stream has a second temperature that is different than the first temperature,
the splitter further configured to direct the first stream through the first channel and direct the second stream through the second channel, a sensor, and
an outlet flow capturing device having an interior gas containment region, the outlet flow capturing device arranged to operationally attach to the casing, receive the first stream and disseminate it within the interior gas containment region.

2. The treatment system of any preceding claim, wherein the splitter includes a vortex spin chamber.

3. The treatment system of any preceding claim, further comprising a cartridge, and the splitter is positioned within the cartridge.

4. The treatment system of any preceding claim, wherein the cartridge comprises an opening configured to interfit with the internal airflow path for receiving an inflow of asphyxiant gas.

5. The treatment system of any preceding claim, wherein the opening is configured to interfit with the first channel.

6. The treatment system of any preceding claim, wherein the splitter comprises a nozzle, the nozzle being disposed at the inlet and coupling with the splitter, and further configured to direct the airflow into the splitter.

7. The treatment system of any preceding claim, wherein the vortex spin chamber is positioned between the first and second channels.

8. The treatment system of any preceding claim, wherein the vortex spin chamber is positioned within the nozzle.

9. The treatment system of any preceding claim, wherein the distal end of the second channel comprises a control valve configured to separate the second stream from the airflow and direct the second stream out of the casing.

10. The treatment system of any preceding claim, wherein the control valve is a conical valve.

11. The treatment system of any preceding claim, wherein the conical valve comprises a truncated conical valve.

12. The treatment system of any preceding claim, wherein the first channel has an axis and the second channel has an axis, the first and second channels positioned so that their respective axes are oriented at an angle.

13. The treatment system of any preceding claim, wherein the first channel axis and an axis of the nozzle form an angle of approximately 90° or less.

14. The treatment system of any preceding claim, wherein the second channel has an axis, and the axis of second channel and an axis of the nozzle form an angle of approximately 90° or less.

15. The treatment system of any preceding claim, wherein the axes of the first and second channels form a 180° angle.

16. The treatment system of any preceding claim, wherein the axes of the first and second channels form an angle ranging between 150°-180°.

17. The treatment system of any preceding claim, wherein the asphyxiant gas comprises at least one of Carbon Dioxide, Nitrogen, Oxygen, Helium, and a combination thereof.

18. The treatment system of any preceding claim, wherein the valve comprises a pressure valve configured to control pressure of the airflow into the inlet.

19. The treatment system of any preceding claim, wherein the valve comprises a digital valve.

20. The treatment system of any preceding claim, further comprising a connector configured to couple the treatment outlet to the flow capturing device.

21. The treatment system of any preceding claim, wherein the flow capturing device is configured to be disposed adjacent to a treatment surface within the interior gas contaminant region and to distribute the first stream over the treatment surface.

22. The treatment system of any preceding claim, wherein the flow capturing device has a distal region with a sealing surface configured to affix to the treatment surface and seal the flow capturing device to an area surrounding the treatment surface.

23. The treatment system of any preceding claim, wherein the distal region has a sealant formulation configured to retain the second stream within the flow capturing device.

24. The treatment system of any preceding claim, wherein the flow capturing device comprises an exterior surface and wherein the treatment connector is disposed on the exterior surface.

25. The treatment system of any preceding claim, wherein the interior gas contaminant region comprises a distribution network of channels, configured to uniformly distribute the first stream within the flow capturing device.

26. The treatment system of any preceding claim, wherein the flow capturing device is a bonnet configured to fit about a person's head.

27. The treatment system of claim 26, wherein the bonnet contains an internal region shaped to correspond to and receive all the hair on the head for example a hair braid, ponytail, or loose bun, gathered up and put into the bonnet.

28. The treatment system of claim 26 or 27, wherein the bonnet includes an inwardly extending diffuser, the diffuser surface having a surface with a plurality of elongate tips, each having a distal orifice through which the asphyxiant gas can exit the interior gas containment region.

29. The treatment system of claim 28, wherein the diffuser surface is shaped as a comb, wherein the elongate tips extend from a central frame and are configured to intersperse through a patient's hair.

30. The treatment system of any of claims 22-29, wherein the bonnet includes an inflatable region.

31. The treatment system of claim 30, wherein the inflatable region extends proximally away from the sealing surface.

32. The treatment system of any preceding claim, further comprising an activation switch coupled to the inlet and configured to control activation of the splitter.

33. The treatment system of any preceding claim, wherein the activation switch comprises a digital switch.

34. The treatment system of any preceding claim, wherein the asphyxiant gas supply source comprises a single-use supply source.

35. The treatment system of any preceding claim, wherein the asphyxiant gas supply source comprises a lid or opening configured to receive a replacement gas.

36. The treatment system of any preceding claim, further comprising a mixing valve coupled to the asphyxiant gas supply source.

37. The treatment system of any preceding claim, comprising a sensor.

38. The treatment system of claim 37, wherein the sensor is included with the interior gas containment region.

39. The treatment system of claim 38, wherein the sensor includes a temperature sensor positioned to monitor temperature of the first stream within the interior gas contaminant region.

40. The treatment system of claim 39, wherein the sensor is positioned between the splitter and the flow capturing device.

41. The treatment system of any of claims 37-40, wherein the sensor includes a chemical sensor configured to monitor concentration of a gas component of the first stream within the interior gas contaminant region.

42. The treatment system of any of claims 37-41, wherein the system is configured to adjust the flow rate of the asphyxiant gas to maintain the asphyxiant gas in the first stream at a predetermined concentration relative to air.

43. The treatment system of any preceding claim, wherein the asphyxiant gas comprises Carbon Dioxide.

44. The treatment system of any preceding claim, wherein the system is configured to control the flow of asphyxiant gas at a predetermined temperature within the interior gas containment region.

45. The treatment system of any preceding claim, wherein the flow capturing device is configured with an outlet valve, comprising a one-way or two-way valve, positioned to direct flow away from the interior gas containment region.

46. The treatment system of claim 45, comprising a recycle loop positioned between a distal end of the outlet valve and the splitter.

47. The treatment system of claim 46, comprising a pump positioned in the recycle loop and operable to drive gas from the interior gas containment region to the splitter through the outlet valve.

48. The treatment system of any preceding claim, wherein the splitter is configured such that it directs the first stream into the first channel at a first angular velocity and directs the second stream in the second channel at a second angular velocity.

49. The treatment system of claim 48, wherein the first angular velocity is smaller than the second angular velocity.

50. The treatment system of any of any preceding claim, wherein the first temperature is lower than the second temperature.

51. The treatment system of any preceding claim, wherein the splitter is configured to provide the first stream into the outlet flow capturing device at a temperature of less than 0° C., less than −10° C., or less than −20° C.

52. The treatment system of claim 51, wherein the temperature of the first stream is approximately −40° C.

53. The treatment system of any preceding claim, wherein the system is configured to provide asphyxiant gas into the outlet flow capturing device at a composition of at least 10% Carbon Dioxide.

54. The treatment system of claim 53, wherein the composition of Carbon Dioxide is in a range of approximately 20%-40%.

55. The treatment system of claim 54, wherein the asphyxiant gas comprises at least 20% Carbon Dioxide.

56. The treatment system of claim 55, wherein the Carbon Dioxide is at least 30%.

57. The treatment system of claim 56, configured to remove air from the first stream to provide Carbon Dioxide in the asphyxiant gas at a composition of at least 80%.

58. The treatment system of claim 57, wherein the asphyxiant gas is 100% Carbon Dioxide.

59. The treatment system of any preceding claim, configured to provide the first stream in the outlet flow capturing device at a temperature of −10 C. to −30 C., for a period of 10 minutes to 40 minutes, and having a composition of 10% to 40% Carbon Dioxide.

60. The treatment system of claim 44, wherein the first angular velocity is larger than the second angular velocity.

61. The treatment system of claim 60, wherein the first temperature is higher than the second temperature.

62. The treatment system of claim 61, configured to provide the first stream in the outlet flow capturing device at a temperature of 100 F to 140 F, optionally for a period of at least 20 minutes up to 40 minutes, and having a composition with 20% to 100% Carbon Dioxide.

63. A method of treating an individual infected with lice in a region of the individual's skin, comprising the steps of:
placing a bonnet on the patient about the infected region of skin,
providing an assembly with a splitting chamber,
providing a flow of asphyxiant gas into the splitting chamber,
separating, in the splitting chamber, a first portion of the flow of asphyxiant gas from a second portion of the flow of asphyxiant gas, the first portion having a temperature than the second portion, and
passing the first portion of the asphyxiant gas from the splitting chamber into the bonnet so as to contact the infected region of the skin.

64. A method of sanitizing an inanimate article that has been exposed to lice, comprising the steps of:
placing the article in a container,
providing an assembly with a splitting chamber,
providing a flow of asphyxiant gas into the splitting chamber,
separating, in the splitting chamber, a first portion of the flow of asphyxiant gas from a second portion of the flow of asphyxiant gas, the first portion having a different temperature than the second portion, and
passing the first portion of the asphyxiant gas from the splitting chamber into the container so as to contact the article.

65. The method of claims 63 or 64, wherein separating the first and second portions of the flow of asphyxiant gas is done by vortexing the flow of asphyxiant gas in the splitting chamber.

66. The method of claim 65, wherein the first portion of the asphyxiant gas is at a lower temperature than the second portion.

67. The method of claim 66, wherein the first portion is directed to the infected region of the skin.

68. The method of claim 67, wherein the first portion of the asphyxiant gas flows into the bonnet for a period of 10-60 minutes.

69. The method of claim 68, wherein the first portion is directed to the article.

70. The method of claim 69, wherein the first portion flows into the container for a period of 5-60 minutes.

71. The method of any of claims 63-70, wherein the first portion has a lower temperature than the second portion.

72. The method of any of claims 63-71, wherein the first portion is at a temperature of between −10° C. and −40° C.

73. The method of claim 72, wherein the temperature is between −20° C. and −40° C.

74. The method of any of claims 63-73, wherein the asphyxiant gas comprises Carbon Dioxide, Nitrogen, Oxygen, Helium, or any combination thereof.

75. The method of claim 74, wherein the asphyxiant gas is Carbon Dioxide in air.

76. The method of any of claims 63-68 or 71-75, comprising a step of monitoring concentration of the asphyxiant gas in the bonnet, as a percentage.

77. The method of claim 76, comprising a step of adjusting the flow rate of asphyxiant gas into the bonnet in response to the monitoring.

78. The method of claim 76 or 77, comprising a step of adjusting the bonnet fit in response to the monitoring.

79. The method of any of claims 63-78, wherein the first stream is provided in the outlet flow capturing device at a temperature of −20C. to −30C., for a period of 20 minutes to 40 minutes, and having a composition of 20% to 40% Carbon Dioxide.

80. The method of any of claims 63-70, wherein the first temperature is higher than the second temperature.

81. The method of claim 80, wherein the first stream flows into the outlet flow capturing device at a temperature of 100 F to 140 F, optionally for a period of at least 20 minutes up to 40 minutes and having a composition with 20% to 100% asphyxiant gas.

82. The method of any of claims 80 or 81, wherein the asphyxiant gas comprises Carbon Dioxide, Nitrogen, Oxygen, Helium, or any combination thereof.

83. The method of claim 82, wherein the asphyxiant gas is Carbon Dioxide in air.

84. The method of any of claims 63 or 65-83, comprising a step of monitoring concentration of the asphyxiant gas in the bonnet, as a percentage.

85. The method of claim 84, comprising a step of adjusting the flow rate of asphyxiant gas into the bonnet in response to the monitoring.

86. The method of claim 85, comprising a step of adjusting the bonnet fit in response to the monitoring.

87. The method of claim 86, comprising monitoring temperature of the asphyxiant gas flowing into the bonnet and, if the temperature reaches a pre-determined threshold, discontinuing flow of asphyxiant gas into the bonnet.

88. The method of any of claims 63-87, comprising applying the system of any of claims 1-62.
